(19) United States
(12) Patent Application Publication
(10) Pub. No.: US 2020/0039841 A1
(43) Pub. Date: Feb. 6, 2020

(54) Distillation and Desalination of Sea Water using Refrigeration units

(71) Applicants: Dariush Habibollah Zadeh, Williamsville, NY (US); Shohreh Moini, Williamsville, NY (US); Betsy Bita Zadeh, Williamsville, NY (US); Shawn Sherwin Zadeh, Williamsville, NY (US)

(72) Inventors: Dariush Habibollah Zadeh, Williamsville, NY (US); Shohreh Moini, Williamsville, NY (US); Betsy Bita Zadeh, Williamsville, NY (US); Shawn Sherwin Zadeh, Williamsville, NY (US)

(21) Appl. No.: 16/055,133

(22) Filed: Aug. 5, 2018

(51) Int. Cl. C02F 1/04; B01D 1/00; B01D 3/00; B01D 5/00

(52) U.S. Cl. CPC C02F 1/041; B01D 1/0047; C02F 2103/08; B01D 5/006; B01D 2202/00; B01D 3/007

(57) ABSTRACT

A new approach for desalination and purification of sea water using refrigeration units is suggested which seems promising to provide high quantities of drinkable water with reasonable cost. The apparatus uses compression refrigeration system to provide heat at the condenser to partially evaporate the intake sea water and uses evaporator at the other side to condense the produced water vapor back to clean drinkable water. A heat recovery heat exchanger captures the heat left in the returning sea water and delivers it to the fresh intake sea water to improve the efficiency and performance. The system can be designed using different refrigerants with some providing higher efficiencies and coefficients of performance. A typical desalination system using this approach shows in theory a production of about 3.6 trillion gallons of potable/drinkable water per year with only about 100 MW electric power installed. Equivalent electrical energy (kWh/m³) consumed by different methods has been reported about 13.5-25.5 kWh/m³ for Multi-stage Flash MSF, about 6.5-11 kWh/m³ for Multi-Effect Distillation MED, about 7-12 kWh/m³ for Mechanical Vapor Compression MVC, and about 3-5.5 kWh/m³ for Reverse Osmosis (RO). The suggested method here would take much less and only a fraction of kWh in theory to produce one cubic meter of potable/drinkable water.

Refrigeration unit can be designed to work under different pressures, different temperatures, different refrigerant flows, different capacities, and different powers. This purification system/apparatus can be utilized to purify sea/ocean water as well as any other type of water with dissolved and/or undissolved impurities. This purification system/apparatus can be designed to include optional processes, equipment and parts.

### BACKGROUND—PRIOR ART

The following is a tabulation of some prior art that presently appear relevant:

### U.S. Patents

| | Kind | | |
|---|---|---|---|
| Patent Number | Code | Publ. Date | Patentee |
| U.S. Pat. No. 9,878,265 | A1 | 2018 Jan. 30 | Hendrix; Glen Truett |
| U.S. Pat. No. 9,816,400 | B2 | 2017 Nov. 14 | Phelps, Sr.; Calvin Eugene |
| U.S. Pat. No. 9,688,548 | A1 | 2017 Jun. 27 | Dette; Severine, etc. |
| U.S. Pat. No. 9,612,059 | A1 | 2017 Apr. 04 | Xiang; XiaoDong, etc. |
| U.S. Pat. No. 9,605,904 | A1 | 2017 Mar. 28 | Ritchey; Jonathan G. |
| U.S. Pat. No. 9,428,403 | A1 | 2016 Aug. 30 | Haynes; Joel |
| U.S. Pat. No. 9,382,135 | B2 | 2016 Jul. 05 | Neil Edwin Moe, |
| | | | John Barber |
| U.S. Pat. No. 9,227,857 | A1 | 2016 Jan. 05 | Sparrow; |
| | | | Benjamin Stuart, etc. |
| U.S. Pat. No. 9,102,545 | A1 | 2015 Aug. 11 | Riley; John D., |
| | | | Johnson; Dana L. |
| U.S. Pat. No. 8,863,547 | A1 | 2014 Oct. 21 | Enis; Ben M., |
| | | | Lieberman; Paul |
| U.S. Pat. No. 8,858,762 | A1 | 2014 Oct. 14 | Young; Anthony D. |
| U.S. Pat. No. 8,801,910 | B2 | 2014 Aug. 12 | Martin Zdenek Bazant, |
| | | | etc. |
| U.S. Pat. No. 8,696,908 | B2 | 2014 Apr. 15 | Peter MacLaggan |
| U.S. Pat. No. 8,647,509 | B2 | 2014 Feb. 11 | Nishith Vora, etc. |
| U.S. Pat. No. 8,377,297 | B2 | 2013 Feb. 19 | Tadd C. Kippeny, etc. |
| U.S. Pat. No. 8,341,961 | B2 | 2013 Jan. 01 | Kenneth P. Glynn |
| U.S. Pat. No. 8,282,791 | A1 | 2012 Oct. 09 | Nirmalakhandan; |
| | | | Nagamany |
| U.S. Pat. No. 7,037,430 | A1 | 2006 May 02 | Donaldson; Burl, etc. |
| U.S. Pat. No. 6,932,889 | B2 | 2005 Aug. 23 | Holcomb; Robert R. |
| U.S. Pat. No. 5,217,581 | B2 | 1993 Jun. 08 | Ewing; Frank A. |
| U.S. Pat. No. 4,009,575 | B2 | 1977 Mar. 01 | Hartman, Jr.; Thomas, etc. |
| U.S. Pat. No. 3,864,932 | B2 | 1975 Feb. 11 | Hsiao; Wan-Om |
| U.S. Pat. No. 3,675,436 | B2 | 1972 Jul. 11 | Ganiaris; Neophytos |

### Introduction (Water Shortage and Treatments)

Freshwater is becoming a major constraint on global development. Water supplies could run out in the next century if water consumption continues to exceed the available fresh water. In the past few decades, clean water has become an emerging controversial issue in the world. People who have the privilege of having clean water from their tap often take it for granted. But those who have to fight for that privilege understand well that how water is important in every aspect of their lives. Neither people, nor ecosystem can survive without clean water. Water is crucial for the survival of humans and the planet. Water is vital for reducing the global burden of disease and improving the health, welfare, and productivity of populations. It is also a critical part of preventing and adapting to climate change, and an essential part of infrastructure. While nearly 70 percent of the world is covered by water, only 2.5 percent of it is fresh. The rest is saline and ocean-based. Even then, just 1 percent of our freshwater is easily accessible, with much of it trapped in glaciers and snowfields. The average person will need 5 liters of water to drink daily to survive in a moderate climate with little activity. Water scarcity has affected more than 40% of the world's population and more than 1.2 billion people globally lack access to clean drinking water. World consumes around 4 trillion cubic meters of fresh water a year. Water is a key factor in managing risks such as famine, migration, epidemics, inequalities, and political instability. Countries which are currently facing extreme water shortage are listed as Yemen, Libya, Jordan, Western Sahara, Djibouti, Mozambique, Rwanda, Haiti, Ethiopia, and Uganda.

At least three principle methods of desalination exist namely; thermal, electrical, and pressure. The oldest method is the thermal distillation which has been around for thousands of years. In thermal distillation, the water is boiled and then the steam is collected, leaving the salt behind. The most common desalination methods employ membrane reverse-osmosis (RO) in which salt water is pumped at high pressure and forced through a membrane (or a series of semi-permeable membranes) that allows water molecules to pass but blocks the molecules of salt and other minerals. Unfortunately, many existing desalination technologies require excessive amounts of energy to operate, making the process costly. Depending on the local energy prices, 1,000 gallons of desalinated seawater can cost around $3 or $4. The installed cost of desalination plants has been reported to be approximately S1 million for every 1,000 cubic meters per day of installed capacity. Therefore, a large scale desalination plant serving 300,000 people typically costs in the region of $100 million. The costs of infrastructure to distribute water must be added to this. Equivalent electrical energy (kWh/m3) consumed by different methods has been reported about 13.5-25.5 for Multi-stage Flash MSF, about 6.5-11 for Multi-Effect Distillation MED, about 7-12 for Mechanical Vapor Compression MVC, and about 3-5.5 for Reverse Osmosis (RO). The suggested method here would take only a fraction of kWh in theory to produce one cubic meter of potable/drinkable water. Desalination plants operate in more than 120 countries in the world, including Saudi Arabia, Oman, United Arab Emirates, Spain, Cyprus, Malta, Gibraltar, Cape Verde, Portugal, Greece, Italy, India, China, Japan, and Australia. Current methods may require about 14 kilowatt-hours of energy to produce 1,000 gallons of desalinated seawater. The cost of distillation is high because we need notable large amount of electricity to heat water in thermal plant and generate high pressure. The desalination plant typically uses three kilograms of seawater to produce 1 kilogram of fresh water. The extracted salt dissolves in the excess sea water used in the process to form so-called brine. The brine is returned to the sea where it is diluted again in its natural medium. The first step in most common water treatments is generally filtering such as sand filters which removes large particulate matter from the water. Utilization of wells for the intake water supply from sea or ocean bed may decrease the need for that kind of treatment.

### SUMMARY

A new approach for desalination and purification of sea water using compression refrigeration (also called “Reverse of Rankine Cycle”) is suggested (components 1-9, 1a-9b, claims 1-12), which seems promising to provide high volume of potable/drinkable water with reasonable cost. The apparatus uses compression refrigeration system (claims 1-4) to provide heat at the condenser (component 2, claims 1-4 and 11) to partially evaporate the intake sea water and uses the evaporator (component 3, claims 1-4 and 12) at the other side to condense the produced water vapor back to clean drinkable water. A heat recovery heat exchanger (9) captures the heat left in the returning sea water (2b) and delivers it to the fresh intake sea water (2a) to improve the efficiency. The system can be designed using many refrigerants with some providing higher efficiencies and coefficients of performance. An ideal Reverse Carnot cycle working between 240° F. and 70° F. indicates a maximum Coefficient of Performance (COP) of about 3.12. A typical actual refrigeration cycle working under the same temperature condition shows a possible COP value of about 2.49 with selected refrigerants. A typical desalination system using this approach shows in theory a production of about 700 billion gallons of drinkable water per year with only about 100 MW electric power installed. Refrigeration unit can be designed to work under different pressures, different temperatures, different refrigerant flows, different capacities, and different powers. This purification system/apparatus can be utilized to purify sea/ocean water as well as any other type of water with dissolved and/or undissolved impurities. This purification system/apparatus can be designed to include optional processes, equipment and parts. Compressors (1) utilized in the system can be of any type including reciprocating, scroll, screw type, rotary, and centrifugal; condensers (2) utilized in the system also can be any type including air-cooled, water-cooled, and evaporative types; and finally, evaporators (3) utilized in the system can be of any type including the bare-tube, plate-type, finned, and finally shell and tube type. All types of refrigerants can be utilized with the suggested systems.

### Advantages

The advantages are:

### (a) Simpler Design

### (b) Integrated System

### (c) Reduced Size

### (d) Better Efficiency and Coefficient of Performance (C.O.P.)

(e) Better economy
(f) Lower kWh to produce one cubic meter of potable/drinkable water
(g) Easier operation, maintenance and repair

### DRAWING/FIGURES

FIG. 1 presents the schematic figure of a typical compression refrigeration unit with the corresponding Pressure-Enthalpy (P-H) diagram (reverse of Rankine cycle).

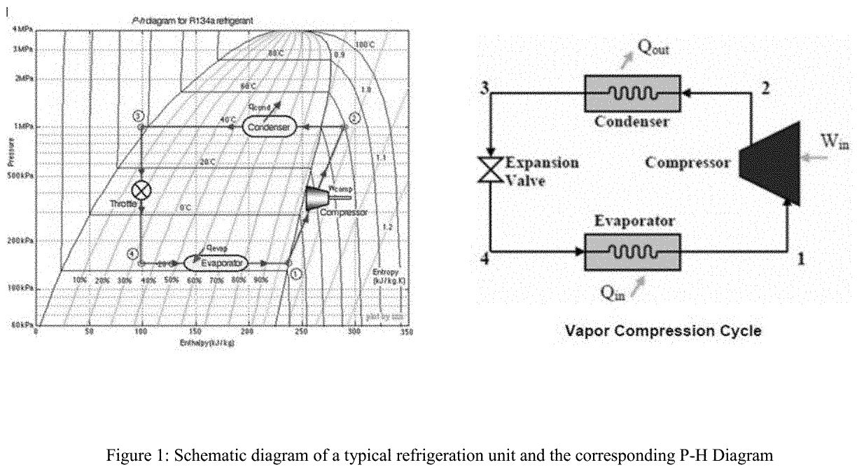

FIG. 2 presents the general schematic diagram of the submitted design in its first embodiment for desalination, distillation, and purification of sea water for consumption and agriculture using refrigeration units.

FIG. 3 shows some details of the submitted design in its first embodiment for the submitted design for desalination, distillation, and purification of sea water.

FIG. 4 presents the general schematic diagram of the submitted design in its second embodiment for desalination, distillation, and purification of sea water for consumption and agriculture using refrigeration units.

FIG. 5 shows some details of the submitted design in its second embodiment for the submitted design for desalination, distillation, and purification of sea water.

FIG. 6 presents general overview of the submitted design and its connection to the corresponding heat recovery process for desalination of sea water.

FIG. 7 shows details of heat recovery for the submitted design.

### REFERENCE NUMERALS (1N FIGURES AND TEXT)

### a) Main Components

1. Compressor
2. Condenser
3. Evaporator
4. Expansion Valve
5. Separation Tank
6. Pressure Reducing Valve (P.R.V.)
7. Closed Air-tight Container
8. Automated Valves
9. Heat recovery Heat Exchanger

### b) Piping

1a Hot gas Line
1b Liquid Line
1c Suction Line
2a Warm Pressurized Sea Water Intake
2b Hot Pressurized Sea Water Outlet
3a Vapor Inlet to Evaporator
3b Fresh Potable/Drinkable Water Outlet from Evaporator
5b Return of Hot Pressurized Concentrated Sea Water to Heat Recovery Heat Exchanger
9a Sea Water Intake (possibly from wells next to sea/ocean)
9b Concentrated Sea Water Return

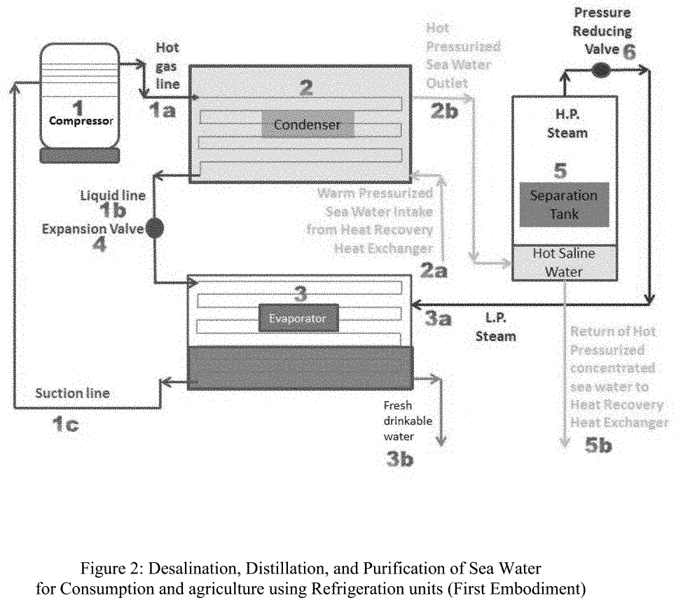

### Detailed Description, FIGS. 2,3,7

### First Embodiment

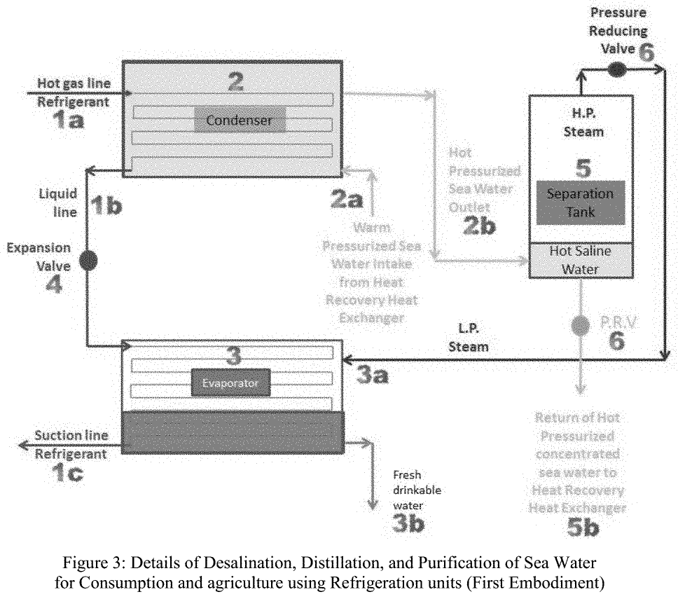

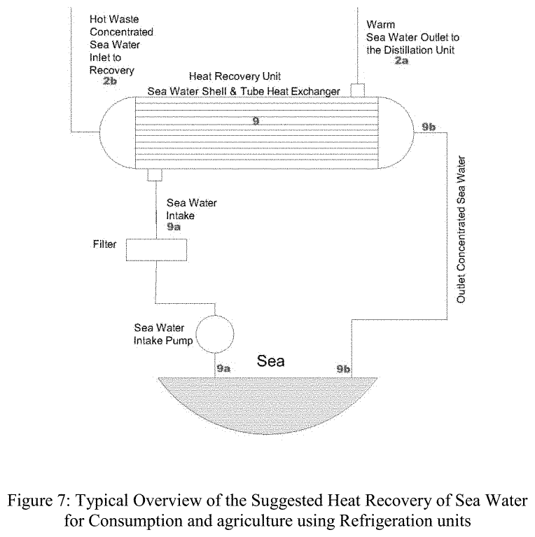

One embodiment of this patent application is presented in FIG. 2. The operation of the systems utilizes a refrigeration unit. Compression refrigeration units are mainly comprised of four components, compressor (1), condenser (2), evaporator (3), and expansion valve (4). The pipeline between compressor and condenser is called “hot gas line” (1a), the pipeline between condenser and expansion valve is called “liquid line” (1b), and the pipe line between evaporator and compressor is called “suction line” (1c). In this embodiment, the condenser and evaporator are closed heat exchangers which let crude/saline water in and out. Condenser (2) heats the intake crude/saline water (2a) and brings it to the boiling temperature but provides only about ⅓ of latent heat for the evaporation of water. This way the quality (x) of saturated crude/saline vapor/water mixture will be about 33.0 percent which means about ⅔ of crude/saline water/vapor mixture would remain in liquid phase and could be returned (2b) to heat recovery heat exchanger (9) and sea to avoid heavy deposits in the condenser. In this embodiment, the outlet vapor/liquid mixture of saline/crude water of condenser (2b) is directed to the separation tank (4) which would separate the water vapor (3a) from liquid crude/saline water (5b) using a pressure reducing valve (6). The water vapor (3a) directed into the closed evaporator (3) will condense inside of the evaporator to produce the desired potable/drinkable fresh water (3b) at the outlet of evaporator. FIG. 2 does not show the details of the process in the next steps. FIG. 3 presents the same process in a detailed close-up view. FIG. 7 shows the details about the water intake system and the heat recovery heat exchanger (9). It shows that how the intake crude/saline water (9a) is pumped through filters into heat recovery heat exchanger (9) where it is heated by the outlet concentrated crude/saline water from condenser (2b), and then directed into the condenser (2a). The concentrated crude/saline water outlet from the heat recovery heat exchanger (9b) is finally returned to the sea/ocean. It should be mentioned that a better intake system from sea/ocean may be done through several wells in vicinity of sea/ocean to climinate most of the undissolved physical particles in the intake water source (9a).

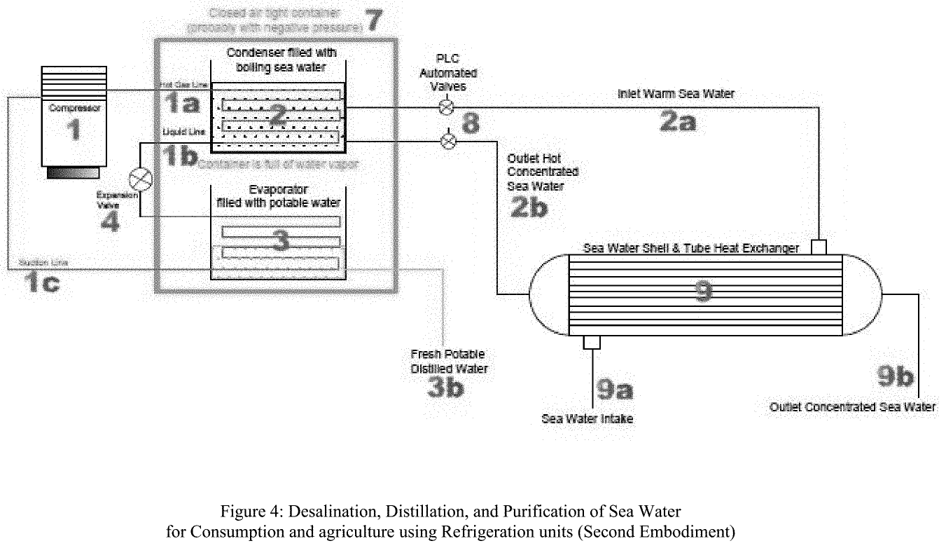

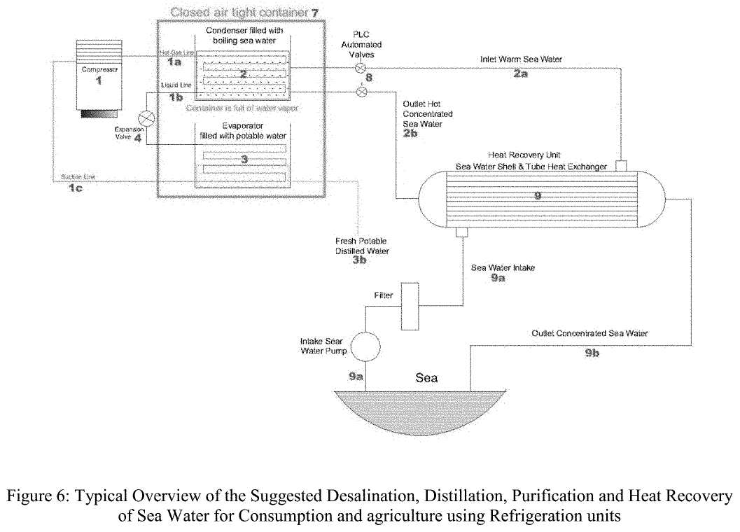

### Detailed Description FIGS. 4 to 7

### Second Embodiment

FIG. 4 presents a schematic drawing of a second embodiment of this patent application. The operation of the systems utilizes a refrigeration unit again.

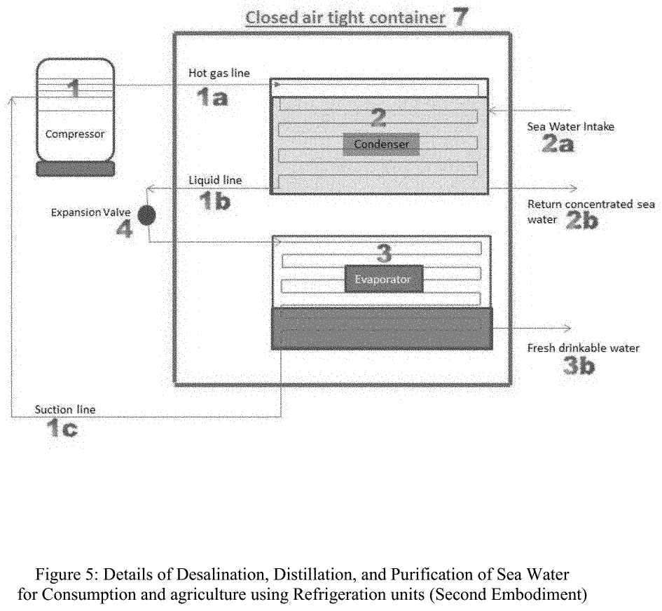

Compression refrigeration units are mainly comprised of four components, compressor (1), condenser (2), evaporator (3), and expansion valve (4). The pipeline between compressor and condenser is called “hot gas line” (1a), the pipeline between condenser and expansion valve is called “liquid line” (1b), and the pipe line between evaporator and compressor is called “suction line” (1e). In the second embodiment, the condenser and evaporator are open heat exchangers which let crude/saline water in and out. Condenser (2) heats the intake crude/saline water (2a) and brings it to the boiling temperature but provides only about ⅓ of latent heat for the evaporation of water. This way the quality (x) of saturated crude/saline water will be about % 33.0 which means about ⅔ of crude/saline water/vapor mixture could be returned (2b) to the heat recovery heat exchanger (9) and eventually to the sea/ocean to avoid heavy deposits in the condenser. In this embodiment, both condenser (2) and evaporator (3) are located in a “closed air-tight container” under different possible arrangements and orders, which allows the generated water vapor inside of the condenser (2) to move to the evaporator (3) and get condensed on the cool evaporator tubes and provide the desired potable/drinkable fresh water (3b). FIG. 5 presents the same second embodiment process in a detailed close-up view. FIGS. 4, 6 and 7 show also the details about the rest of process, i.e. water intake system and the heat recovery heat exchanger (9). They shows how the intake crude/saline water (9a) is pumped through filters into heat recovery heat exchanger (9) where it is heated by the outlet concentrated crude/saline water from condenser (2b), and then directed into the condenser (2a). The concentrated crude/saline water outlet from the heat recovery heat exchanger (9b) is finally returned to the sea/ocean. It should be mentioned that a better intake system from sea/ocean may be done through several wells in vicinity of sea/ocean to eliminate most of the undissolved physical particles in the intake water source (9a).

### Operation

In the first embodiment, condenser (2) and evaporator (3) are closed heat exchangers. So the flow of crude/saline water in and out through them should be brought to a different tank (i.e. a separation tank (5)) to facilitate the separation of water vapor from the water liquid. Pressures are adjusted in this tank using pressure reducing valves to assure proper operation of the process. Due to a separate separation tank, the control of the process should be easier with the use of automated valves (8).

In the second embodiment, condenser (2) and evaporator (3) are open heat exchangers. So the flow of crude/saline water in and out through them would not need a separate tank. But both condenser and evaporator would be located in a “closed air-tight container” (7) under different possible arrangements to facilitate the transfer of water vapor from condenser into evaporator. This type of design would probably need less equipment but it may have limitations with operational modes. The design would similarly use automated valves (8) to control the flows, mode of operation and the process output.

### ADDITIONAL RAMIFICATIONS

Additional ramifications may include applications with other refrigerants, applications for purposes other than water treatment, and applications to process other liquids and fluids.

In general, the suggested system may couple with current technologies in different fields to bring up more effective processes and technologies.

The extents of claims are defined as:

1. All systems/apparatuses for desalination, distillation and purification of any sort of water including sea/ocean water using one or combination of several compression-refrigeration unit(s) (claims 2-4).

2. In one embodiment, the system (claim 1) is comprised of one or several compressor(s) (1), condenser(s) (2), evaporator(s) (3), expansion valve(s) (4), separation tank(s) (5), heat recovery heat exchanger(s) (9), in addition to piping (1a, 1b, 1c, . . . ), pump(s), filter(s), valve(s), automation equipment and sea water intake equipment/facilities (6,8).

3. In a second embodiment, the system (claim 1) is comprised of one or several compressor(s) (1), condenser(s) (2), evaporator(s) (3), expansion valve(s) (4), closed air-tight separation container(s) (7), heat recovery heat exchanger(s) (9), in addition to piping (1a, 1b, 1c, . . . ), pump(s), filter(s), valve(s), automation equipment (8) and sea water intake equipment/facilities.

4. The Refrigeration unit (claim 1) is of compression type (also called reverse of Rankine cycle) and is comprised of compressor(s) (1), condenser(s) (2), evaporator(s) (3), expansion valve(s) (4) and all other necessary or routine piping (1a, 1b, 1c), valves, filters, tanks, electrical or mechanical instruments, and other necessary or optional parts to run the system.

5. Refrigeration unit (claims 1-4) can be designed to work with all and any new or old refrigerant(s).

6. Refrigeration unit (claims 1-4) can be designed to work under different pressures, different temperatures, different refrigerant flows, different capacities, different design quality values and different powers.

7. This purification system/apparatus (claims 1-4) can be modified to purify sea/ocean water as well as any other type of water or any kind of liquid and fluid with dissolved and/or undissolved impurities, The suggested process may get coupled with current technologies in different fields to bring up more effective new processes and technologies.

8. This purification system/apparatus (claims 1-4) can be designed to utilize regular and modified routine refrigeration components and parts, The intake water system may utilize wells to obtain sea water with less undissolved materials.

9. This purification system/apparatus (claims 1-4) can be designed differently by rearrangement of components/parts or by addition of side or optional processes, equipment and parts.

10. Compressors utilized in the system (component 1, claims 1-4) can be any type of reciprocating, scroll, screw type, rotary, centrifugal or any other type.

11. Condensers utilized in the system (component 2, claims 1-4) can be any type of air-cooled, water-cooled, evaporative or any other type.

12. Evaporator utilized in the system (component 3, claims 1-4) can be any type of bare-tube, plate-type, finned, shell and tube or any other type.
